(19) United States
(12) Patent Application Publication
(10) Pub. No.: US 2005/0200746 A1
(43) Pub. Date: Sep. 15, 2005

(54) Digital camcorder having a digital still camera unified therein and manufacturing method thereof

(75) Inventor: Kyoung-Jin Ahn, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/045,403

(22) Filed: Jan. 31, 2005

(30) Foreign Application Priority Data
Mar. 10, 2004 (KR) 2004-16051

(51) Int. Cl. H04N 5/225

(52) U.S. Cl. 348/373

(57) ABSTRACT

A DSC-unified digital camcorder comprises a first module and a second module. The first module comprises a first side of an external structure of the digital camcorder and ca first half. The first module comprises a first camera unit to convert an image entered through a lens into a digital moving image signal, and a first board that is electrically connected with the first camera unit and processes the moving image signals captured through the first camera unit. The second module comprises a second side of the external structure of the digital camcorder and a second half. The second module comprises a second camera unit to convert an image entered through a lens into a digital still image signal, and a second board that is electrically connected with the second camera unit and processes the still image signal captured through the second camera unit.

### CROSS-REFERENCE TO RELATED APPLICATIONS

This application claims the benefit under 35 U.S.C. §119(a) of Korean Patent Application No. 2004-16051, entitled “DIGITAL CAMCORDER HAVING A DIGITAL STILL CAMERA UNIFIED THEREIN AND MANUFACTURING METHOD THEREOF”, filed Mar. 10, 2004, in the Korean Intellectual Property Office, the entire contents of which are expressly incorporated herein by reference.

### BACKGROUND OF THE INVENTION

1. Field of the Invention

The present invention relates to a digital camcorder and a manufacturing method thereof. More particularly, the present invention relates to a DSC-integrated digital camcorder, which has a digital video camera (DVC) and a digital still camera (DSC) unified therein to record and reproduce moving and still images, respectively, and a manufacturing method thereof.

2. Description of the Related Art

Digital camcorders are presently available that include a DSC function that can capture desired images in accordance with a variety of preferences of a user. The digital camcorder can then store the signals of still images in a memory card, and print the stored signal through a printer or replay it through a PC.

A DSC-added digital camcorder usually photographs and reproduces moving and still images by processing the image signals captured through the DVC section of the camcorder. Although this type of digital camcorder provides the advantage of minor modifications to the existing camcorder, because the DVC section of the existing camcorder is generally of low resolution (for example, 720×480 pixels for a DV type camcorder), the image quality of still images that are captured through the DVC section is generally of a lower quality.

In order to prevent or minimize the drawbacks discussed above, it has been suggested to add a DSC section to the digital camcorder together with the DVC section. A DSC-unified digital camcorder can therefore photograph and reproduce moving and still images.

Such a DSC-unified digital camcorder has a fixed image quality, which is, irrespective of the resolution of DVC section, determined according to the resolution of the DSC section. This means the high resolution of DSC section would result in high resolution still images, but at the same time, complicated constructions and assemblies are required to integrate the DVC and DSC sections with distinctive functions into a single product.

Other problems also can arise when integrating the DVC and DSC into a single product. For example, performance testing of each of the DVC and DSC sections is not possible before the assembling process. Accordingly, the DVC and DSC sections are performance tested after assembly, and minor defects, which would otherwise be detected and corrected before assembly, results in the entire product being rejected. As a result, productivity decreases.

Furthermore, because the DVC and DSC sections are not easily separable in either the functional or physical sense, design or programming errors in either the DVC or DSC sections cannot be easily or appropriately dealt with. As a result, the entire camcorder has to be disassembled if the need for repair arises.

Therefore, in order to provide a DSC-unified digital camcorder that is simple in structure and easy to manufacture, assemble and repair, performance tests on each of the DVC and DSC sections have to be enabled before assembly. Also, the DVC and DSC sections require structures that enable easy assembly and disassembly.

### SUMMARY OF THE INVENTION

The present invention has been developed in order to solve the above drawbacks and other problems associated with the conventional arrangement. An aspect of the present invention is to provide a DSC-unified digital camcorder that enables performance testing and evaluation before final assembly, and also enables easy assembly and disassembly. The DSC-unified digital camcorder provided in such a manner can be manufactured with higher productivity and can be more easily repaired.

The above aspects and/or other features of the present invention can substantially be achieved by providing a DSC-unified digital camcorder comprising a first module constituting a first side of the digital camcorder and constituting a first half, the first module comprising a first camera unit to convert an image entered through a lens into a digital moving image signal, and a first board that is electrically connected with the first camera unit and processes the moving image signal captured through the first camera unit. The DSC-unified digital camcorder further comprises a second module constituting a second side of the digital camcorder and constituting a second half, the second module comprising a second camera unit to convert an image entered through a lens into a digital still image signal, and a second board that is electrically connected with the second camera unit and processes the still image signal captured through the second camera unit.

The first module of the DSC-unified digital camcorder comprises a deck assembly comprising a deck unit electrically connected with the first board, the first board and the first camera unit, each being engaged with each other, a first outer assembly comprising an opening corresponding to the deck unit, and comprising at least one of a zoom knob, a photo shutter, a mode selection switch and a recording button electrically connected with the first board, the first outer assembly covering a side of the deck assembly, and a deck cover assembly comprising a door casing that has a recording medium mount part to mount thereon a recording medium such as a memory card, the deck cover assembly for opening and closing the opening of the first outer assembly. The first module of the DSC-unified digital camcorder still further comprises a rear assembly engaged with the deck assembly to cover the rear side of the deck assembly, and comprising a rear casing that has a battery mount part on the outer side thereof and a third board that is supported within the rear casing, the third board being electrically connected with the first board.

The second module of the DSC-unified digital camcorder comprises a second outer assembly comprising the second camera unit, a first display unit electrically connected with the second board, and a second outer casing that has a speaker unit, a plurality of connecting ports for communication with external device, and a plurality of function keys for selection of menus displayed through the first display unit which are electrically connected with the second board, the second outer assembly covering the other side of the deck assembly. The second module of the DSC-unified digital camcorder also comprises an upper assembly engaged with the deck assembly to cover the upper side thereof. The upper assembly comprises an upper casing that has a flash unit movable inside and outside and supports the second display unit, and a microphone unit that is supported on the upper casing.

The second camera unit of the DSC-unified digital camcorder is supported on a side of the second board such that the first and the second camera units are arranged side by side in a substantially vertical direction when the second camera is engaged with the first outer assembly and the deck assembly. The second board is arranged substantially parallel with the first board, and electrically connected with the first board when engaged with the deck assembly.

The DSC-unified digital camcorder according to an embodiment of the present invention further comprises a front assembly to seal off the first camera unit of the first module and the second camera unit of the second module from the front side. The front assembly comprises a front casing comprising a first and a second lens hoods that are open to correspond to the first and the second camera units, and a sensor module supported within the front casing, and comprising a remote control sensor and an illuminating light sensor that are electrically connected with one of the first and the second boards.

According to one aspect of the present invention, an assembling method for a DSC-unified digital camcorder, comprises preparing a first module constituting a first side of the digital camcorder and constituting a first half, the first module comprising a first camera unit to convert an image entered through a lens into a digital moving image signal, and a first board which is electrically connected with the first camera unit and processes the moving image signal captured through the first camera unit, testing the first module, and preparing a second module constituting a second side of the digital camcorder and constituting a second half, the second module comprising a second camera unit to convert an image entered through a lens into a digital still image signal, and a second board that is electrically connected with the second camera unit and processes the still image signal captured through the second camera unit. The method of assembling a DSC-unified digital camcorder further comprises testing the second module, and assembling the first and the second modules, and electrically connecting the first and the second boards.

The step of preparing a first module of the method for assembling a DSC-unified camcorder according to an embodiment of the present invention comprises testing electrical and physical operations of the deck unit, at least one of the zoom knob, photo shutter, mode selection switch, and recording button. The step of preparing a first module further comprises testing electrical and physical operations of a recording medium mount part to mount thereon a recording medium such as a memory card, and a third board to control a battery, all of which are electrically connected with the first board of the first module.

The step of testing the second module of the method for assembling a DSC-unified camcorder according to an embodiment of the present invention comprises testing electrical and physical operations of a second outer assembly comprising the second camera unit, a first display unit and a second outer casing having a speaker unit, and a plurality of function keys to select menus displayed through the first display unit, which are electrically connected with the second board, and an upper assembly comprising a flash unit and a microphone unit which are electrically connected with the second board.

The step of assembling the first and second modules of a method for assembling a DSC-unified camcorder according to an embodiment of the present invention comprises assembling the first and the second camera units side by side in a substantially vertical direction.

The method for assembling a DSC-unified camcorder according to an embodiment of the present invention further comprises engaging and assembling a front assembly to the first and the second modules to seal off the first camera unit of the first module and the second camera unit of the second module from the front side, and testing a sensor module of the front assembly.

The step of testing a sensor module of the method for assembling a DSC-unified digital camcorder according to an embodiment of the present invention comprises testing electric operation of a remote control sensor, an illuminating light sensor and an infrared light emitting element, each being mounted on the board of the sensor module.

### BRIEF DESCRIPTION OF THE DRAWINGS

The above aspects and features of the present invention will be more apparent by describing certain embodiments of the present invention with reference to the accompanying drawings, in which:

FIG. 1 is a perspective view of a DSC-unified digital camcorder according to an embodiment of the present invention;

FIG. 2 is an exploded perspective view of the digital camcorder of FIG. 1

FIG. 3 is an exploded perspective view of a DVC module of the digital camcorder of FIG. 2;

FIG. 4 is an exploded perspective view of a DSC module of the digital camcorder of FIG. 2;

FIG. 5 is a perspective view of a DVC module of the digital camcorder of FIG. 2; and

FIG. 6 is a perspective view illustrating the DVC module and the DSC module of FIG. 2 being connected with each other.

### DETAILED DESCRIPTION OF THE PREFERRED EMBODIMENTS

Several embodiments of the present invention will now be described in detail with reference to the annexed drawings. In the drawings, the same or similar elements are denoted by the same reference numerals throughout the drawings. In the following description, a detailed description of known functions and configurations incorporated herein have been omitted for conciseness and clarity.

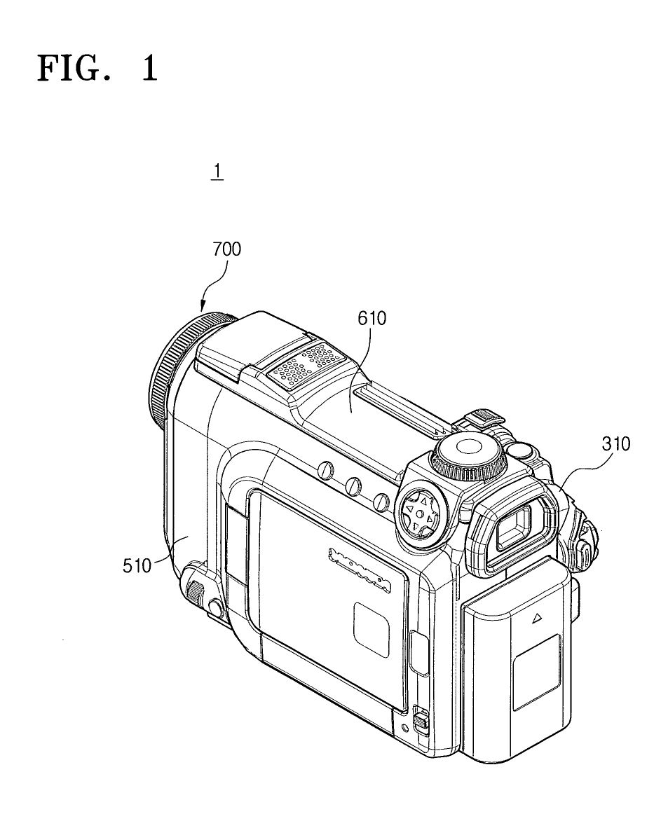

FIG. 1 shows a DSC-unified digital camcorder 1 according to an embodiment of the present invention. The DSC-unified digital camcorder 1 according to an embodiment of the present invention comprises a DVC module and a DSC module that are separately constructed, and perform a DVC and DSC function, respectively. According to an embodiment of the present invention, functional performance of the DVC and DSC modules can be tested before the final assembly of the product, and assembly and disassembly of the DVC and DSC modules is more easily accomplished. As a result, manufacturing the DSC-unified digital camcorder 1 in this manner results in higher productivity yields, and makes it substantially easier to maintain and repair the DSC-unified digital camcorder 1.

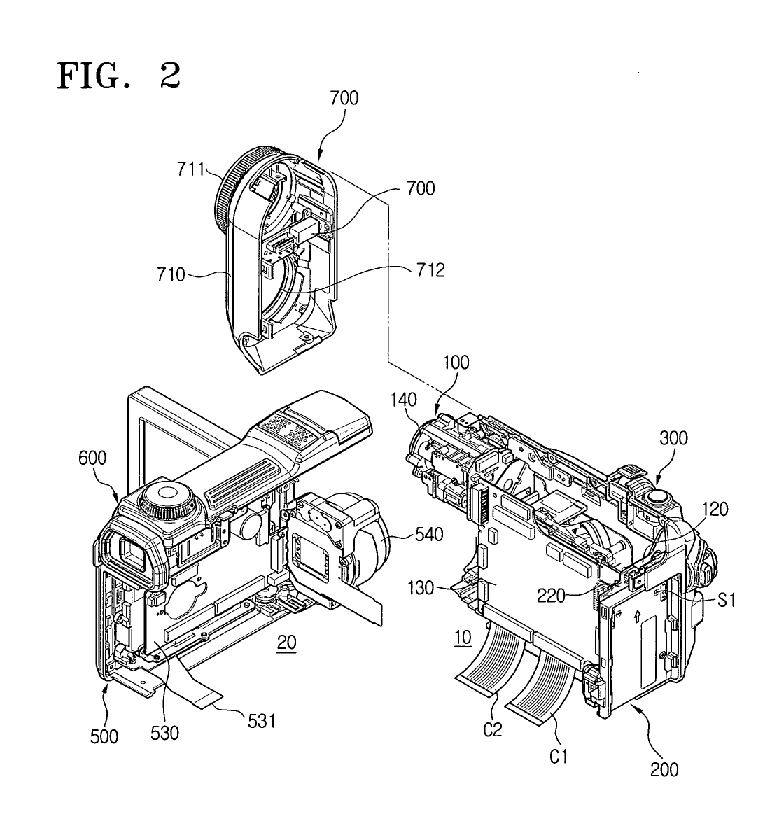

Referring to FIG. 2, the DSC-unified digital camcorder 1 according to an embodiment of the present invention comprises a DVC module 10 that occupies a first side of the product and a first half, and a DSC module 20 that occupies a second side of the product and a second half. The DSC-unified digital camcorder 1 further comprises a front assembly 700 that seals off the front of the DVC module 10 and the DSC module 20.

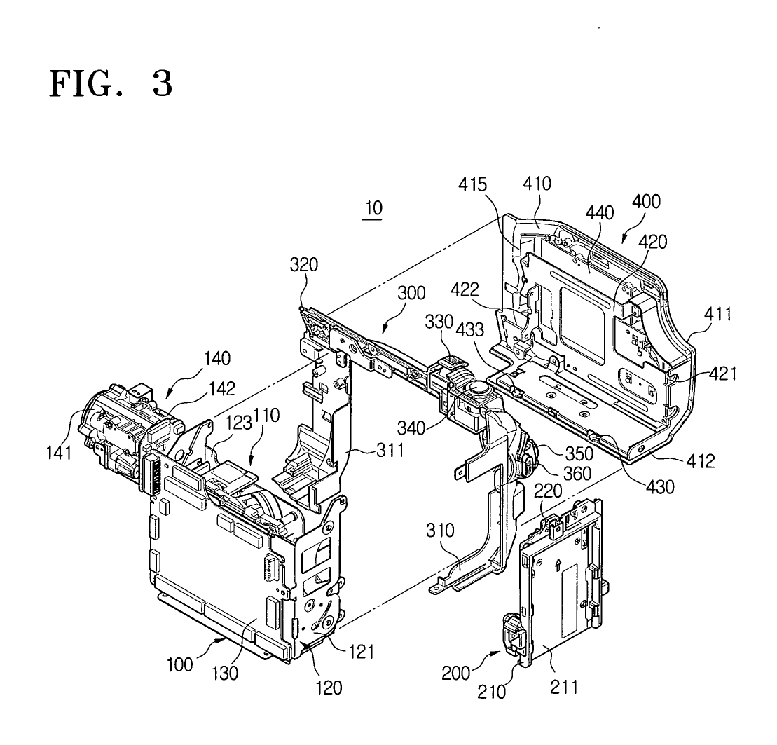

The DVC module 10 shown in FIG. 3 has the main function of photographing moving images. The DVC module 10 comprises a deck assembly 100 having a deck unit 110, a main board 130 and a first camera unit 140 engaged with each other, and a first outer assembly 300 having an opening 311 corresponding to the deck unit 110 and encompassing one side of the deck assembly 100. The DVC module 10 further comprises a deck cover assembly 400 for opening and closing the opening 311 of the first outer assembly 300, and a rear assembly 200 encompassing the rear side of the deck assembly 100.

The deck assembly 100 comprises the deck unit 110, a deck housing 120, the main board 130 and a first camera unit 140. The deck unit 110 operates to record data, including images, in the magnetic tape, and to reproduce the recorded data. To accomplish the recording and reproducing of data, the deck unit 110 has a head drum. The deck unit 110 is constructed such that a sub deck moves on a main deck, loading and unloading the tape cassette to the head drum. This is generally-known construction, as one skilled in the art would appreciate, and therefore, further description will be omitted for the sake of brevity.

The deck housing 120 encompasses and supports the deck unit 110. The deck housing 120 has a main frame 121 on which the deck unit 110 is seated, and a door frame 123 hingedly engaged with the upper portion of the main frame 121. The door frame 123 is openably engaged with the main frame 121 to open the upper portion of the deck unit 110 when the tape cassette is mounted and dismounted with respect to the deck unit 110. The door frame 123 is engaged with a deck cover assembly 400.

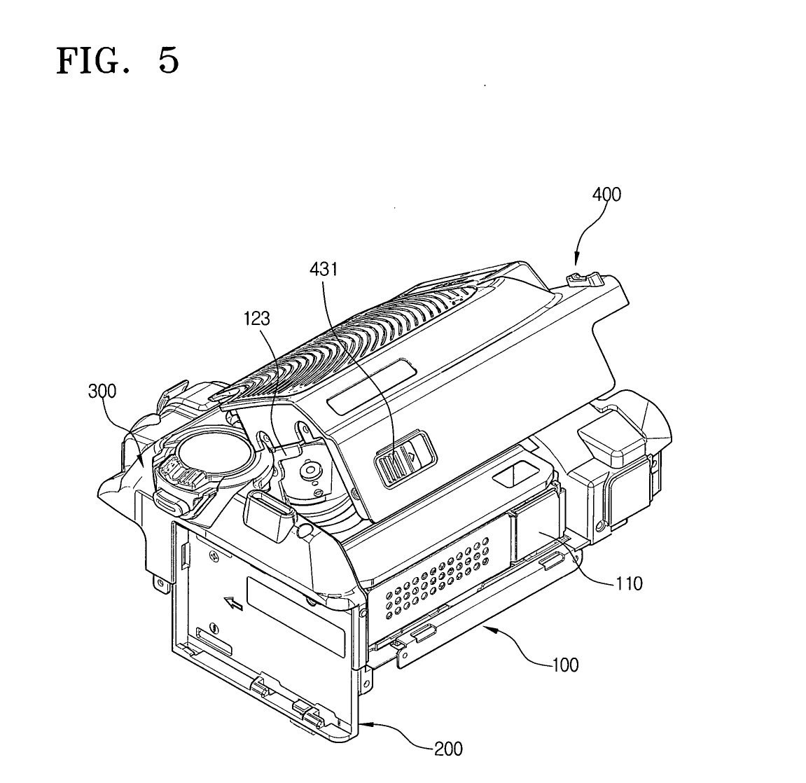

Referring to FIG. 5, when the deck cover assembly 400 is opened, the door frame 123 is also opened, exposing the deck unit 110 to the exterior. Therefore, a tape cassette can be mounted and dismounted through the open side. The deck housing 120 can be formed of a metal material by press finishing.

Referring back to FIG. 3, the main board 130 is positioned to correspond to the deck unit 110, with the main frame 121 interposed therebetween. The main board 130 controls the processing of image signals captured through the first camera unit 140 and the recording of the processed signal in the magnetic tape through the head drum. The main board 130 is electrically connected to the deck unit 120 and the first camera unit 140 for signal transmission and reception via a connector or flexible printed circuit (FPC). Additionally, the main board 130 is electrically connected to control the respective components (described below), directly or indirectly through a signal cable.

The first camera unit 140 is engaged and supported on the deck housing 120 and the main board 130. The first camera unit 140 includes a digital video camera to mainly capture moving images. The digital video camera is of the type that are generally employed in camcorders. The first camera unit 140 has an infrared filter inside a camera lens barrel 141 to capture images at night. A filter lever 142 is movably mounted on the outside of the camera lens barrel 141 to turn on and off the infrared filter.

The rear assembly 200 is positioned on the deck housing 120 by screws. The rear assembly 200 can be fixed to the main frame 121 at a position opposite to the first camera unit 140. The rear assembly 200 comprises a rear casing 210, and a rear board 220 engaged with the inner side of the rear casing 210. A battery mount part 211 is formed on the outside of the rear casing 210. The rear board 220 is electrically connected with the main board 130 via the signal cable, and therefore, controlled by it.

The first outer assembly 300 is engaged with the deck assembly 100, and covers the right part of the deck assembly 100. When engaged, the first outer assembly 300 also covers an edge of the rear assembly 200 that has been assembled before the first outer assembly 300. The first outer assembly 300 comprises a first outer casing 310, preferably manufactured by a molding process, and an infrared filter operating unit 320 supported on the first outer casing 310. The first outer casing 310 has an opening 311 corresponding to the door frame 123 of the deck unit 110. The opening 311 is opened and closed by the deck cover assembly 400. The infrared filter operating unit 320 is movably formed on the first outer casing 310, and is connected to move the filter lever 142 according to its movement. The first outer casing 310 includes a zoom knob 330 to adjust the focal distance of the lense to a subject photograph, a photo shutter 340 to capture still images, a mode selection switch 350 to select the photographing mode between moving and still images, and a recording button 360. The zoom knob 330 and the photo shutter 340 can be integrated into a single module and installed in the first outer casing 310 such that it is exposed to the user. The zoom knob 330, the photo shutter 340, the mode selection switch 350 and the recording button 360 are all connected via the signal cable (not shown) to the main board 130 through a shared terminal. One or more of the zoom knobs 330, the photo shutter 340, the mode selection switch 350 and the recording button 360 can be installed in the first outer casing 310, while others are installed in the other assembly.

The deck cover assembly 400 comprises a cover casing 410 preferably manufactured by a molding process, a support frame 420 engaged inside the cover casing 410, and a locking/unlocking unit 430 provided inside the cover casing 410. The cover casing 410 comprises a sidewall 411 with a configuration that corresponds to that of the opening 311 of the first outer casing 310, and a lower sidewall 412 bent and extended from the lower end of the sidewall 411. The sidewall 412 encompasses and therefore covers the lower side of the deck unit 110. The support frame 420 is preferably made of metal material, and engaged to the door frame 123 of the deck housing 120, preferably by a screw fastening. The locking/unlocking unit 430 comprises a slidable release knob 431 (shown in FIG. 5) exposed to the outside of the lower sidewall 412, and a slidable hook member 433 engaged with the slidable releasing knob 431. The slidable hook member 433 is biased toward a certain direction by a spring (not shown).

The cover casing 410 has a recording medium mount part 415 onto which a recording medium, such as a memory card, is mounted. The cover casing 410 includes a circuit board 440 electrically connected to the recording medium, at a position corresponding to the mount part 415. When the first outer casing 300 is assembled with the deck assembly 100, referring to FIG. 5, the door frame 123 of the deck housing 120 is opened, the deck cover assembly 400 is mounted on the opened door frame 123, and the support frame 420 is fastened by screws.

In the DVC module 10 constructed as above, the deck unit 120 of the deck assembly 100, the first camera unit 140, the rear board 220 the zoom knob 330, the photo shutter 340, the mode selection switch 350, the recording button 360, and the circuit board 440 are all electrically connected with the main board 130 for the purpose of control. Because the DVC module 10 can be tested prior to being assembled with the DSC module 20, functional tests can be conducted before final assembly.

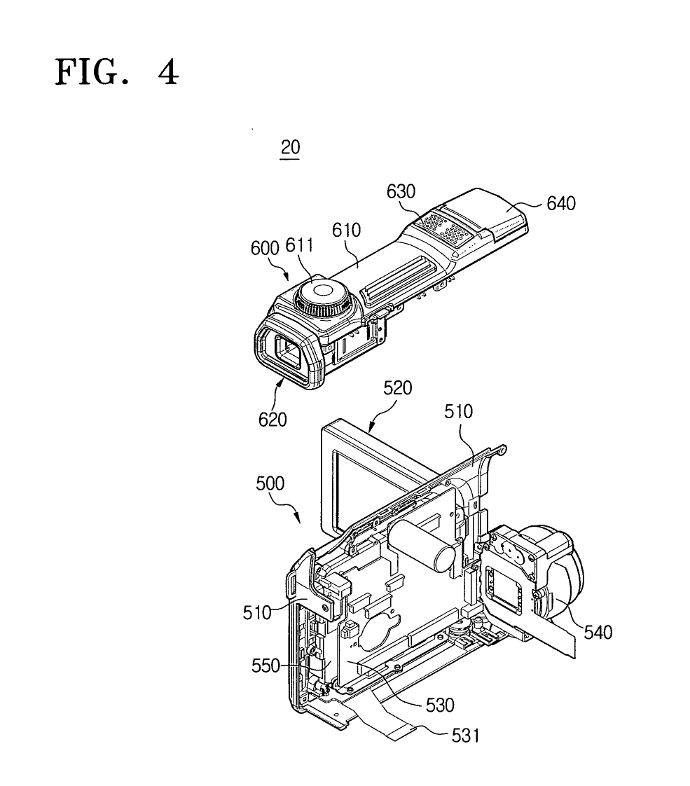

Referring to FIG. 4, the DSC module 20 comprises a second outer assembly 500 that encompasses the other side of the deck assembly 100 and has a second camera unit 540 and a first display unit 520, and an upper assembly 600 engaged to cover the upper portion of the deck assembly 100 and has a second display unit 620. The second outer assembly 500 comprises a second outer casing 510, the first display unit 520 engaged with the outer side of the second outer assembly 510, the sub board 530 and the second camera unit 540.

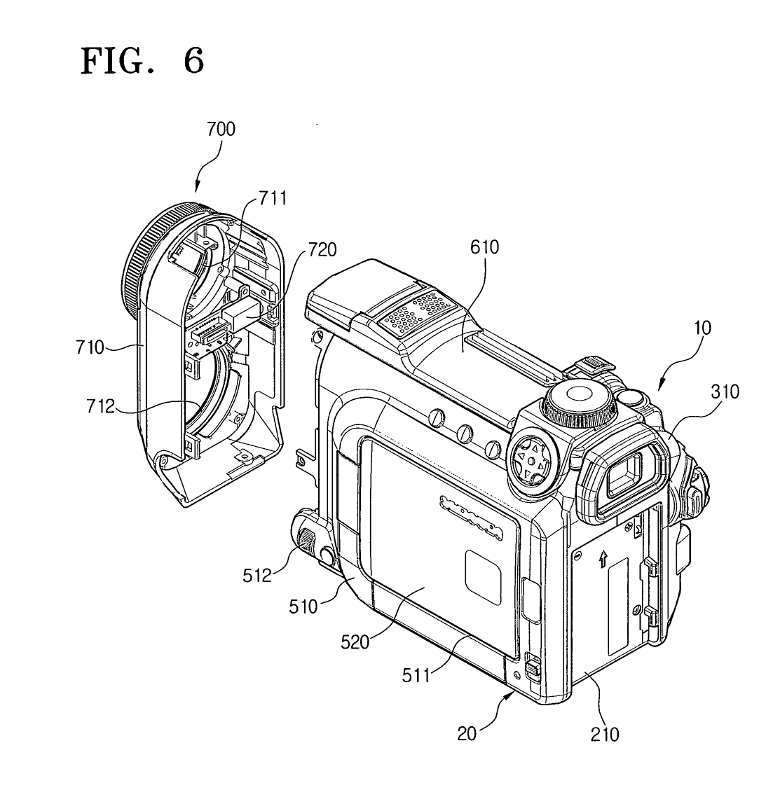

The second outer casing 510 encompasses the left side of the deck assembly 100, that includes a side of the main board 130. Referring to FIG. 6, the second outer casing 510 is preferably made of a plastic material, and preferably manufactured by a molding process, and has a display mount part 511 on the outside. The display mount part 511 is recessed inward to receive the first display unit 520 therein. The second outer casing 510 has a roll switch 512 for the selection of menus. A hole cover 550 to cover the display mount part 511 from within (shown in FIG. 4), has a speaker unit (not shown) and a plurality of function keys (not shown) formed thereon. Various other function keys can also be formed on the second outer casing 510.

The first display unit 520 preferably comprises an LCD panel, and is rotatably mounted on the second outer casing 510 about two axes. Images photographed through the first and the second camera units 140 and 540, or images reproduced from the recording medium, are displayed through the first display unit 520. The first display unit 520 is electrically connected to the sub board 530 by one or more cables.

Referring now to FIG. 4, the sub board 530 is connected inside the second outer casing 510. The sub board 530 electrically connects the first display unit 520 and the second camera unit 540. Additionally, when the first outer assembly 500 is assembled with the deck assembly 100, the sub board 530 is connected to the main board 130 by a FPC 531. The sub board 530 and the main board 130 are arranged side by side facing each other, and connected through the FPC. Accordingly, incoming signals or processed still image signals are transmitted to the main board 130, and control signals are transmitted to the sub board 530. The roll switch 512, the speaker unit and the function keys are electrically connected to the sub board 530.

The second camera unit 540 preferably comprises a digital still camera that is usually used to photograph still images. As known to those skilled in the art, the second camera unit 540 has a CCD containing a large amount of pixels so as to photograph images of higher resolution than the first camera unit 140. The second camera unit 540 is engaged with an end of the sub board 530. The second camera unit 540 is engaged to the lower end of the sub board 530 during the assembling of the second outer assembly 500 and the deck assembly 100 so that the second camera unit 540 can be positioned under the first camera unit 140.

The upper assembly 600 comprises the upper casing 610, the second display unit 620, a microphone unit 630, and a flash unit 640. The upper casing 610 covers an upper part of the deck assembly 100, and is assembled to the second outer casing 510. The second display unit 620 preferably comprises a viewfinder unit. The microphone unit 630 and the flash unit 640 are engaged to the upper casing 610, while being exposed to the outside environment. In an embodiment of the present invention, the first and the second camera units 140 and 540 are arranged side by side in the front side, and, for efficient utilization of space, the microphone unit 630 and the flash unit 640 are installed on the upper casing 610 at the upper portion of the DSC-unified digital camcorder. The microphone unit 630 and the flash unit 640 can be installed on at least one of either the first outer assembly 300, the second outer assembly 500 or the front assembly 700. The flash unit 640 is mounted to move inside and outside at the upper casing 610. The second display unit 620, the microphone unit 630 and the flash unit 640 are electrically connected to the sub board 530.

A plurality of function key modules 611 are installed on the upper casing 610 for the DSC function of the second camera unit 540. The function key modules 611 are also electrically connected to the sub board 530.

In the DSC module 20 constructed as above, the second display unit 620, the microphone unit 630, the flash unit 640, the roll switch 512 for menu selection, the speaker unit, and the function keys are all electrically connected to the sub board 530 and controlled therefrom. Therefore, functional testing of the aforementioned functions is possible without requiring a connection with the DVC module 10 (i.e., before final assembly).

Referring again to FIG. 6, the front assembly 700 seals off the front side of the DVC and DSC modules 10 and 20 and thereby covers the front side of the DSC-unified digital camcorder that is equipped with the first and the second camera units 140 and 540. The front assembly 700 comprises a front casing 710 and a sensor module 720 that is installed inside the front casing 710. The front casing 710 has first and second lens hoods 711 and 712 that are opened to correspond to the respective camera units 140 and 540. The lens hoods 711 and 712 are mounted side by side in a vertical direction, and are preferably fabricated as a separate component to be assembled in the front casing 710.

The sensor module 720 comprises a remote control sensor, a main illuminating light sensor, a sub illuminating light sensor, and infrared light emitting elements. The sensor module 720 is electrically connected to the sub board 530 or the main board 130. The sensor module 720 can be functionally tested after the front assembly 700 is assembled to the DVC and DSC modules 10 and 20.

The DSC-unified digital camcorder 1 according to the embodiments of the present invention described above comprises a DVC module 10, a DSC module 10 and a front assembly 700, which are respectively constructed to have separate structures and functions. Therefore, functional testing of each module and assembly can be accomplished prior to final assembling of the product. Additionally, the DVC and the DSC units are easy to assemble and disassemble.

An exemplary assembling process of the DSC-unified digital camcorder constructed as above according to an embodiment of the present invention will now be described. As shown in FIG. 2, the three assemblies of the DSC-unified digital camcorder comprise the DVC module 10, the DSC module 20 and the front assembly 700, each of which can be separately manufactured and tested. Each of the three assemblies are prepared through separate assembling processes.

To prepare the DVC module 10, the rear assembly 200 is assembled with the deck assembly 100. Then, the rear assembly 200 is fastened to the deck housing 120 of the deck assembly 100 by screws S1. Next, the rear board 220 and the main board 130 of the rear assembly 200 are electrically connected via the FPC.

The first outer assembly 300 is then assembled to the deck assembly 100 and the rear assembly 200 by screws. The infrared filter operating unit 320 of the first outer assembly 300 is engaged to the infrared filter operating lever 142. The respective parts 330, 340, 350, 360 of the first outer assembly 300 are then electrically connected to the main board 130 via the FPC.

At this point in the manufacturing process, the deck housing 120 is exposed to the right side through the opening 311 of the first outer casing 310. The door frame 123 of the deck housing 120 is opened through the exposed opening 311 (FIG. 5).

With the door frame 123 opened, the deck cover assembly 400 is assembled to the door frame 123. The fastening parts (not shown) of the door frame 123 are aligned with the fastening parts 421 and 422 of the support frame 420, and the respective fastening parts are engaged with each other by screws. When the deck cover assembly 400 is completely assembled, the deck cover assembly 400 is closed, and as a result, the DVC module 10 having four assemblies 100, 200, 300, 400 is completely assembled.

The DVC module 10 then undergoes a series of test processes. Accordingly, electric and physical operational status of the components, which are electrically connected with the main board 130, occurs. These include the deck unit 120 of the deck assembly 100, the first camera unit 140, the rear board 220 to control battery status, zoom knob 330, photo shutter 340, mode selection switch 350, the recording button 360 and the circuit board 440 that is connected with the recording medium, are inspected through a series of test processes.

Referring now to FIG. 4, to assemble the DSC module 20, first, the upper assembly 600 is assembled with the second outer assembly 500. The upper casing 610 is assembled with the second outer casing 510 by using screws. Then the microphone unit 630, the flash unit 640 and the second display unit 620 of the upper assembly 600, are electrically connected to the sub board 530 by using the FPC. As a result, the DSC module 20 is completely assembled.

The DSC module 20 then undergoes a series of test processes. Accordingly, electric and physical operational status of the components, which are electrically connected with the sub board 530 occurs. This includes the second display unit 620 to display images captured through the second camera unit 540, the microphone unit 630, the flash unit 640, the roll switch 512 for menu selection, the speaker unit and various function keys, are inspected through a series of test processes.

After the DVC and DSC modules 10 and 20 have been assembled and tested, (as shown in FIG. 2), the DVC and DSC modules 10 and 20 are faced toward each other and assembled (as shown in FIG. 2). To accomplish this, the main board 130 and the sub board 530 are electrically connected to each other by circuit cables C1 and C2. The circuit cable 531 of the DSC module 20 is also connected to the main board 130. The boards 130 and 530 now face each other, and the second camera unit 540 is positioned under the first camera unit 140. Accordingly, as shown in FIG. 6, the DVC and DSC modules 10 and 20 are connected with each other to form the shape of the DSC-unified digital camcorder 1. After the two modules 10, 20 are assembled together, the first and the second outer casings 310 and 510, the upper casing 610, and the rear casing 210 are fastened to each other by screws.

After the DVC and the DSC modules 10 and 20 have been assembled with each other, as shown in FIG. 6, the front assembly 700 is engaged to the front side of the two attached modules 10, 20, and is fastened to the respective outer casings 310 and 510 and the upper casing 610 by the screws. As a result, the front assembly 700 is completely assembled and attached to the DVC and DSC modules 10, 20.

As a final step, the functioning of the sensor module 720 of the front assembly 700, which includes the remote control sensor, the main illuminating light sensor, the sub illuminating light sensor and the infrared light emitting elements, is tested. The DSC-unified digital camcorder 1 is now substantially assembled.

In the several embodiments of the present invention as described, a DSC-unified digital camcorder 1 and an assembling method thereof is provided to separately construct the DVC module of DVC function and the DSC module comprising the DSC function. Furthermore, assembly and disassembly of the DVC and DSC modules 10, 20 becomes more convenient, and therefore, manufacturing, productivity and ease of maintenance increases.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A DSC-unified digital camcorder, comprising:
a first module comprising a first side of the digital camcorder and a first half, the first module comprising a first camera unit to convert an image entered through a lens into a digital moving image signal, and a first board that is electrically connected with the first camera unit and processes the moving image signal captured through the first camera unit; and
a second module comprising a second side of the digital camcorder and a second half, the second module comprising a second camera unit to convert an image entered through a lens into a digital still image signal, and a second board that is electrically connected with the second camera unit and processes the still image signal captured through the second camera unit.

2. The DSC-unified digital camcorder of claim 1, wherein the first module comprises:
a deck assembly comprising a deck unit electrically connected with the first board, the first board and the first camera unit, each being engaged with each other;
a first outer assembly comprising an opening corresponding to the deck unit, and comprising at least one of a zoom knob, a photo shutter, a mode selection switch and a recording button electrically connected with the first board, the first outer assembly covering a side of the deck assembly;
a deck cover assembly comprising a door casing that has a recording medium mount part to mount thereon a recording medium such as a memory card, the deck cover assembly for opening and closing the opening of the first outer assembly; and
a rear assembly engaged with the deck assembly to cover the rear side of the deck assembly, and comprising a rear casing that has a battery mount part on the outer side thereof and a third board that is supported within the rear casing, the third board being electrically connected with the first board.

3. The DSC-unified digital camcorder of claim 2, wherein the second module comprises:
a second outer assembly comprising the second camera unit, a first display unit electrically connected with the second board, and a second outer casing that has a speaker unit, a plurality of connecting ports for communication with external device, and a plurality of function keys for selection of menus displayed through the first display unit that are electrically connected with the second board, the second outer assembly covering the other side of the deck assembly; and
an upper assembly engaged with the deck assembly to cover the upper side thereof, and comprising an upper casing that has a flash unit movable inside and outside and supports the second display unit, and a microphone unit which is supported on the upper casing.

4. The DSC-unified digital camcorder of claim 3, wherein the second camera unit is supported on a side of the second board such that the first and the second camera units are arranged side by side in a substantially vertical direction when the second camera is engaged with the first outer assembly and the deck assembly.

5. The DSC-unified digital camcorder of claim 3, wherein the second board is arranged substantially parallel with the first board, and electrically connected with the first board when engaged with the deck assembly.

6. The DSC-unified digital camcorder of claim 3, further comprising a front assembly to seal off the first camera unit of the first module and the second camera unit of the second module from the front side.

7. The DSC-unified digital camcorder of claim 6, wherein the front assembly comprises:
a front casing comprising a first and a second lens hoods that are open to correspond to the first and the second camera units; and
a sensor module supported within the front casing, and comprising a remote control sensor and an illuminating light sensor that are electrically connected with one of the first and the second boards.

8. An assembling method for a DSC-unified digital camcorder, comprising:
preparing a first module comprising a first side of the digital camcorder and a first half, the first module comprising a first camera unit to convert an image entered through a lens into a digital moving image signal, and a first board that is electrically connected with the first camera unit and processes the moving image signal captured through the first camera unit;
testing the first module;
preparing a second module comprising a second side of the digital camcorder and a second half, the second module comprising a second camera unit to convert an image entered through a lens into a digital still image signal, and a second board that is electrically connected with the second camera unit and processes the still image signal captured through the second camera unit;
testing the second module; and
assembling the first and the second modules, and electrically connecting the first and the second boards.

9. The assembling method of claim 8, wherein the step of preparing a first module comprises:
testing electrical and physical operations of a deck unit at least one of a zoom knob, photo shutter, a mode selection switch, and a recording button, a recording medium mount part to mount thereon a recording medium such as a memory card, and a third board to control a battery, all of which are electrically connected with the first board of the first module.

10. The assembling method of claim 8, wherein the step of testing the second module comprises:
testing electrical and physical operations of a second outer assembly comprising the second camera unit, a first display unit and a second outer casing having a speaker unit, and a plurality of function keys to select menus displayed through the first display unit, which are electrically connected with the second board, and an upper assembly comprising a flash unit and a microphone unit that are electrically connected with the second board.

11. The assembling method of claim 8, wherein the step of assembling the first and second modules comprises:
assembling the first and the second camera units side by side in a substantially vertical direction.

12. The assembling method of claim 8, further comprising:
engaging and assembling a front assembly to the first and the second modules to seal off the first camera unit of the first module and the second camera unit of the second module from the front side; and
testing a sensor module of the front assembly.

13. The assembling method of claim 12, wherein the step of testing a sensor module comprises:
testing electric operations of a remote control sensor, an illuminating light sensor and an infrared light emitting element, each being mounted on the board of the sensor module.
